(19) United States
(12) Patent Application Publication
(10) Pub. No.: US 2007/0056674 A1
(43) Pub. Date: Mar. 15, 2007

(54) Method and device for making towel, tissue, and wipers on an air carding or air lay line utilizing hydrogen bonds

(75) Inventor: William Sellars, Milwaukee, WI (US)

Correspondence Address: MICHAEL BEST & FRIEDRICH, LLP, 100 E WISCONSIN AVENUE, MILWAUKEE, WI, 53202, US

(73) Assignee: Sellars Absorbent Materials, Inc., Milwaukee, WI (US)

(21) Appl. No.: 11/519,504

(22) Filed: Sep. 12, 2006

Related U.S. Application Data
(60) Provisional application No. 60/716,582, filed on Sep. 12, 2005.

(51) Int. Cl. B05D 7/00; B27N 3/00

(52) U.S. Cl. 156/62.2; 427/421.1; 264/109

(57) ABSTRACT

Methods and machines for forming a non-woven web. In one embodiment, the machine includes one or more forming boxes. Each box has an associated fiber inlet. The forming boxes are positioned above a conveyor table. Fibrous material travels from the inlet through each forming box. A vacuum source is located underneath the conveyor table and generates an air current that pulls the fibrous material onto the conveyor table to form a web or sheet of fibrous material. In one embodiment, the fibrous sheet is formed in three layers. Vapor or steam boxes are placed adjacent to each forming box. In one embodiment, a steam box is located within the entrance of an oven. The sheet is subjected to a vapor, mist, fog, spray, or steam (generically referred to as a “suspension”) as it passes under each steam box. In one embodiment, the suspension is generated with water. Applying a water suspension to the fibrous materials provides hydrogen atoms to help create hydrogen bonding between at least some of the fibers. As compared to wet laid forming, hydrogen bonds are created with much less water and with an associated reduction of cost in water handling and utility expenses to dry or remove water. In addition, mixtures of natural and synthetic fibers and relatively longer fibers may be used as compared to wet-laid processes to improve strength. Bulk density may be controlled by forming patterned layers of material and laminating the patterned layers. One benefit of applying vapor to the forming web is that vapor helps with laying down fibers and smoothing of the sheet. This is more particularly noticed with sheets where relatively longer synthetic fibers have been added to increase strength.

### RELATED APPLICATIONS

This application claims priority to U.S. Provisional Patent Application No. 60/716,582; filed on Sep. 12, 2005.

### BACKGROUND

Embodiments of the invention relate to non-woven material that can be used to make various products, such as paper towels, tissue paper, wipers, napkins, and the like as well as methods of making such products.

Generally, paper towels or wipers can be made using either a wet-laid or wet-forming process, variations of wet forming known as single recreping and double recreping, or a dry-laid, air-laid, or dry-forming process.

Wet laying or forming includes creating a slurry of water and pulp. The slurry is formed into a web on a paper-making machine. Single recreping (“SRC”) includes impregnating a wet-formed sheet of paper with binder and creping one of its surfaces. Double recreping (“DRC”) includes impregnating a wet-formed sheet of paper with binder and creping both of its surfaces. Dry laying or forming includes applying fibers to a mesh table or conveyor with a vacuum and then bonding the material to hold the fibers together.

### SUMMARY

The above processes have some shortcomings. Generally, wet-laid materials are held together by hydrogen bonds. However, since hydrogen bonds are dissolvable in water, the wet strength of wet-formed material is inherently limited. In addition, the length or size of the fibers used in wet-formed materials is limited due to the inability of most paper machines to handle relatively long fibers.

SRC and DRC provide generally acceptable end products, but are relatively expensive. This is, in part, because the first step in SRC and DRC relies on paper produced on a traditional, wet-laid paper machine. Such machines are expensive to operate and maintain.

In dry-laid processes, the tensile strength of a non-woven material can be increased by applying a bonding agent, such as latex, to create a film over one or more surfaces of the material. However, applying latex in this manner often decreases softness and wipe-ability.

Accordingly, it would be desirable to have improved methods and devices for creating materials suitable for use as paper towels, wipers, and the like.

In one embodiment, the invention provides a machine for forming a non-woven web. The machine includes one or more forming heads or boxes. Each box has an associated fiber inlet. The forming boxes are positioned above a conveyor table. Fibrous material travels from the inlet through each forming box. A vacuum source is located underneath the conveyor table and generates an air current that pulls the fibrous material onto the conveyor table to form a web or sheet of fibrous material. In one embodiment, the fibrous sheet is formed in three layers.

Vapor or steam boxes are placed adjacent to each forming box. In one embodiment, a steam box is located within the entrance of an oven. The sheet is subjected to a vapor, mist, fog, spray, or steam (generically referred to as a “suspension”) as it passes under each steam box. In one embodiment, the suspension is generated with water. Applying a water suspension to the fibrous materials provides hydrogen atoms to help create hydrogen bonding between at least some of the fibers.

Optional calender rolls can be located within the steam boxes. These optional calender rolls can be used to control the thickness of the sheet. The calender rolls can also be patterned to impart a desired pattern on the sheet or each layer thereof. The calender rolls can also be heated to help maintain the sheet at a desired temperature.

Other aspects and embodiments will become apparent by consideration of the detailed description and accompanying drawings.

### BRIEF DESCRIPTION OF THE DRAWINGS

FIG. 1 is an illustration of a dry-forming machine, particularly an air-carding machine used to form a non-woven web of material.

FIG. 2 is an illustration of a binder fiber.

FIG. 3 is an illustration of system in which a dry-formed, non-woven web is bonded and creped (which is shown particularly as double recreping).

FIG. 4 is a flow chart illustrating a process of creating a dry-formed, non-woven, creped material.

FIG. 5 is an illustration of an air-forming machine with associated vapor boxes and an oven.

FIG. 6 is an illustration of a multi-layered sheet formed in the air-forming machine of FIG. 5.

FIG. 7 in another illustration of a multi-layered sheet.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

As is discussed in greater detail below, one feature of certain embodiments of the invention is that loosely-held fibers in an air- or dry-laid web may be passed through a “steam” box or spray station and treated with water or water vapor. These treatment process helps with fiber lay-down (weighing down fibers such that they do not stick out or project from a web) and creates hydrogen bonds to help create sufficient strength for the web to undergo downstream processes such as “printing” (which in one form relates to the application of adhesive, as opposed to ink) and creping processes (discussed below). In alternative embodiments, hydrogen bonding of the web may be supplemented or replaced, in various combinations and permutations, with chemical bonding (e.g., bonding created with adhesives) and thermal bonding (e.g., bonding created by melting the sheath in a bicomponent fiber).

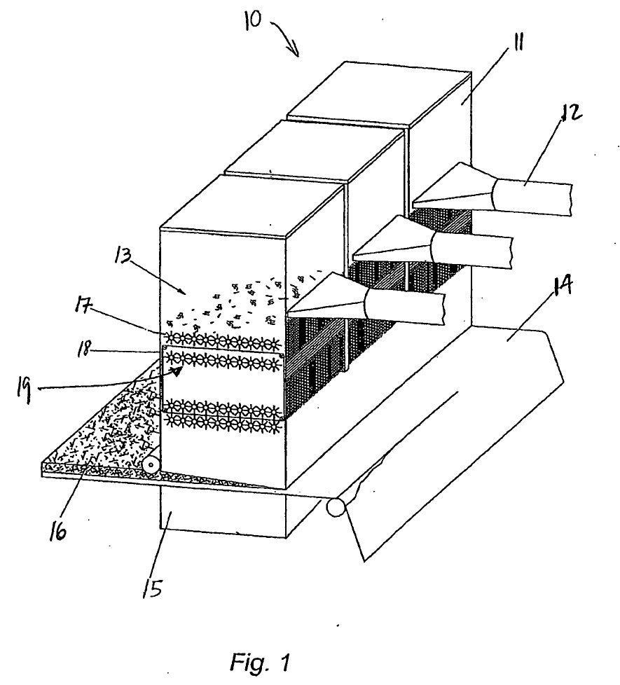

FIG. 1 illustrates an air- or dry-laid forming box or former 10. The former 10 includes a housing 11 into which fibrous material 13 is supplied from inlets 12. The forming box 10 is positioned above a conveyor table 14 onto which the fibrous material 13 is air laid. A vacuum box 15 located underneath the forming screen (e.g., conveyor table 14) is connected to a vacuum fan (not shown) that generates an air current that pulls fibrous material onto the conveyor table 14 to form a web or sheet 16 of fibrous material. The conveyor table 14 is made from a mesh material or otherwise includes a plurality of openings for concurrently allowing air to flow therethrough and retain the fibrous material 13 thereon. It is to be understood that the forming box 10 illustrated in FIG. 1 indicates only one configuration of a dry-forming machine and that other configurations may be possible.

Using dry-forming techniques, as opposed, for example, to wet-laid processes, makes it easier to produce a low-density base web or sheet 16. In addition, dry forming makes it easier to use longer fibers, such as fibers of about 2.5 cm in length. In some instances, this represents an increase of about ten times the length used in webs formed in wet-laid processes. Longer fibers help to increase the bulk and strength of a web.

The fibrous material 13 supplied through inlets 12 can include natural fibers, such as pulp or cellulose fibers, animal hair, fibers from flax, hemp, jute, ramie, sisal, cotton, kapok, glass, old newsprint, elephant grass, sphagnum, seaweed, palm fibers, or the like. Natural fibers that have been processed or modified can also be used. It is also possible to use synthetic fibers or combinations of natural, modified, and synthetic fibers. Synthetic fibers that can be used include polyamide, polyester, polyacrylic, polypropylene, bicomponent, vermiculite fibers, and others. Depending on the particular application or desired use for the end product, the fibers or combination of fibers can be selected to have insulating, absorption, softness, specified chemical reactivity, strength, and other desirable characteristics. One advantage of dry-forming is that relatively long fibers can be used to form a web. Long fibers tend to help increase the strength of a web. The fiber or fibrous material 13 can be shredded and sized prior to being provided to the inlets 12.

In one embodiment, (which for convenience is referred to as the “pulp/binder fiber embodiment”) paper or pulp fibers are used as a primary ingredient in the sheet 16. In one version of this embodiment, the pulp fibers are treated or processed prior to being dry laid. In particular, the fibers are processed using a debonder to reduce hydrogen bonding. As is known, hydrogen bonds are one type of bonding that hold paper fibers together. Reducing the amount of bonding can impact the resulting strength, elasticity, bulk thickness, and softness of paper. Other additives can be used to treat the pulp prior to the dry-laying process.

In one embodiment, dried, direct-entry recycled pulp can be used. In order to debond this pulp, debonder can be applied at a number of places in the process. For example, a liquid debonder can be applied to the pulp in a spray booth or station, an example of which is described below. After being treated with the liquid debonder, the pulp can be dried in a dryer prior to being introduced to a forming head. It is possible when using a multi-head former to introduce recycled fiber, which tends to be rough, in a centrally located head or box while introducing virgin fiber in outer heads or boxes. Mixing fibers in this way tends to increase softness.

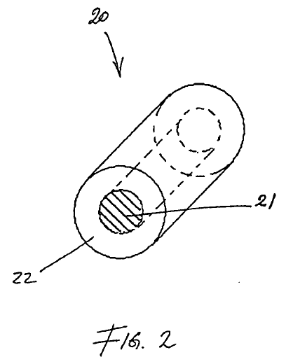

Another ingredient in the pulp/binder fiber embodiment is synthetic fiber or binder fiber. The pulp fibers can be mixed with binder fibers prior to being dry laid. As the name suggests, binder fiber helps bind or hold together the other fibers in the sheet. Binder fibers can also impart certain characteristics such as elasticity and strength. An exemplary binder fiber 20 is shown in FIG. 2. The fiber 20 has a core 21 and a sheath outer layer 22. In one embodiment, the outer layer 22 has a first melting temperature and the core 21 has a second melting temperature higher than the first melting temperature 22. (The core and outer layer are usually made from different materials and in this form the fiber 20 is often referred to as a bicomponent fiber). When the fiber 20 is heated, the outer layer 22 tends to melt before the core 21. Binder fibers comprising fibers 20 are mixed with paper fibers or cellulose. The mixture is formed into a sheet and subjected to heat. Heating the sheet causes the outer layer 22 in the fibers 20 to melt, which creates numerous thermal bonds in the sheet. Additional details of this process are set out below. Some commercially available binder fibers include sheath outer layers made of materials that tend to melt at temperatures above about 200° F.

It is possible that a bicomponent fiber with a core of Lyocell material may also be used. Lyocell is less expensive than many types of material used in the core of bicomponent fibers. As is known Lyocell is classified as a type of Rayon material and can be manufactured using an organic solvent spinning process.

It is possible that the fibrous material 13 can be supplied into the housing 11 in lumps. Spike rollers 17 and a belt screen 18 combined in an arrangement 19 can be included in the housing 11 to disintegrate or shred the lumps of fibrous material 13 in order to help provide a substantially even distribution of fibrous material 13 on the conveyor table 14. In the particular version illustrated, the former 10 includes two rows of spike rollers. Fibrous material 13 passes a first row of spike rollers 17, the belt screen 18, and a second row of spike rollers 17 as the fibrous material is sucked downward to the conveyor table 14 due to the vacuum 15.

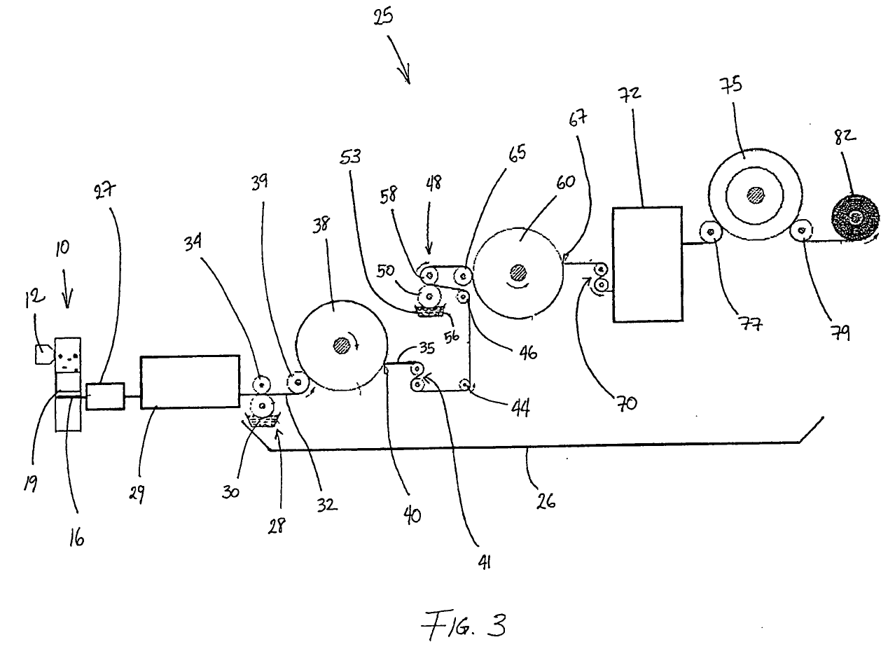

FIG. 3 illustrates a system 25 where the sheet 16 formed in the former 10 is strengthened and then delivered to a creping line 26. When initially formed on the conveyor table 14, the fibers in the sheet 16 are loosely bonded and the sheet 16 is generally not in a condition where it can be used in an end product such as paper towels or the like. In some embodiments, the sheet can be passed through spray station 27 which can be used to apply an adhesive, latex, water, or other material to the sheet 16. Although the station 27 is referred to as a spray station, the material can be sprayed on or applied in a mist, vapor, fog, steam, or other manner. Steam has some advantages because it helps to heat the sheet and enhance any temperature or heat curing process that occurs in subsequent steps.

In addition or in the alternative to being processed in the spray station 27, the sheet 16 can be passed through an oven 29 or similar device to heat the sheet 16. The oven 29 can be configured to force or blow hot air through the web or sheet 16. In the pulp/binder fiber embodiment, the binder fiber in the sheet melts, creating thermal bonds that connect or adhere the melted fibers with other fibers to strengthen the sheet 16. Although the spray station 27 and an oven 29 are discussed in this detailed description as one way of bonding a dry-formed sheet of material, it is possible that other techniques of strengthening a loosely-bonded, air-laid sheet can be used. For example, it is possible to spray or otherwise apply an adhesive on or to the sheet, or otherwise bond the fibers in the sheet which after being initially air laid are generally held together by the vacuum force on the former 10.

In some embodiments, the sheet 16 is bonded in the oven 29 such that it is strong enough to be printed and pressed to a dryer, but weak enough to develop bulk during creping. This can be accomplished by adding sufficient binder fiber and thermally bonding the sheet 16 to increase its tensile strength to at least about 280 grams per inch.

Once formed and bonded, the sheet 16 passes through a first bonding-material application station or rotogravure printer 28, where additional bonding material, such as liquid bonding material 30 is applied to a first side 32 of the sheet 16 in a fine pattern corresponding to a pattern in or on a roll 34. The liquid bonding material 30 can be liquid latex. A second side 35 of the sheet 16 can also be modified, as is described below. In some embodiments, the bonding material 30 is applied on the first side 32 of the sheet 16 to produce a 1-to-1 ounces per inch tensile strength ratio to base weight. In some embodiments, the base weight of the sheet 16 is from about 20 to about 200 pounds per ream (for a 3000 square foot ream). In certain embodiments, use of a printer provides an ability to adjust the depth that the bonder material penetrates the sheet 16, primarily by adjusting the depth of the groove in the printer. The ability to adjust the depth of penetration provides flexibility in manufacturing a sheet possessing desired properties. For example, less penetration usually results in greater bulk, but less strength. On the other hand, greater penetration usually increases strength, but decreases bulk. In addition to adjusting the depth of penetration, the surface area to which bonding material is applied can also be adjusted, for example, by adjusting the pattern of printing. In some embodiments, only 40 to 50 percent of the surface area of the sheet is covered with bonding material to provide desired absorbency and desirable dry wipe characteristics.

As bonding material 30 is applied to the sheet 16, the moisture content of the sheet increases. The sheet 16 is delivered or passed to a dryer or heated drum (also known as a creping or Yankee dryer) 38. The sheet 16 is pressed into adhering contact with the drum 38 by press roll 39. The bonding material 30 causes only those portions of the sheet 16 where the bonding material 30 is disposed to adhere tightly to the drum 38.

The sheet 16 is carried on the surface of the drum 38 for a distance sufficient to heat the bonding material 30 enough to tightly adhere the sheet 16 to the drum 38 and dry the sheet 16 (or decrease its moisture content). The sheet 16 is removed from the drum 38 by a creping blade 40. As is known, the blade 40 forces the sheet 16 to change direction very quickly. During this rapid change in direction, the sheet 16 collides into the crepe blade, stops momentarily, and is folded or bent in an accordion-like manner to form a first, controlled-pattern crepe in the sheet 16.

The sheet 16 is pulled from the creping blade 40 through a pair of driven pullrolls 41 and then is advanced about turning rolls 44 and 46 to a second printer or material-application station 48. In some embodiments, the pullrolls 41 are optional, thus the sheet 16 is pulled by action of station 48, a dryer drum (discussed below), or both. The station 48 includes a first roll 50 that is positioned to draw a second bonding material 53 from a trough 56 and a pattern roll 58. In some embodiments, the station 48 is identical or substantially similar to the station 28. Likewise, the bonding material 53 can be the same as the bonding material 30. The station 48 applies bonding material on the second surface 35 of the sheet 16 in a pattern arrangement that can be the same as that of the first bonding material, although alternative patterns can be used.

After applying the second bonding material to the sheet 16, the sheet 16 is delivered to a second dryer or heated drum 60 and pressed into adhering contact with the drum 60 by press roll 65. The sheet 16 is carried on the surface of the second drum 60 for a distance and then removed by action of a second creping blade 67. The second drum 60 and the second creping blade 67 perform a second, controlled-pattern creping operation on or to the sheet 16.

The sheet 16 is then pulled from the creping blade 67 with a second set of driven pullrolls 70 and then advanced to a curing station 72. In some embodiments, the pullrolls 70 are optional and the sheet 16 is advanced directly from the creping blade 67 to the curing station 72 by the action of components in the curing station 72 or subsequent components. The sheet 16 is heated in the curing station 72 to a temperature that is sufficient to cure the bonding material 30 and 56. In one embodiment, the sheet is heated to a temperature of about 380° F. The sheet 16 is then moved to a large cooling roll 75 to lower the temperature of the sheet 16. The sheet 16 is pressed against the large cooling roll 75 by rolls 77 and 79. The sheet 16 is then wound into a roll (often referred to as a parent roll) 82.

In some embodiments, the sheet 16 is processed prior to delivering it to the creping line 26. In particular, running the dry-forming machine or former 10 at a higher speed than the speed of the creping line 26 can create a facsimile of creping in the sheet 16. This pre-processing can, among other things, increase the absorbency of the end product.

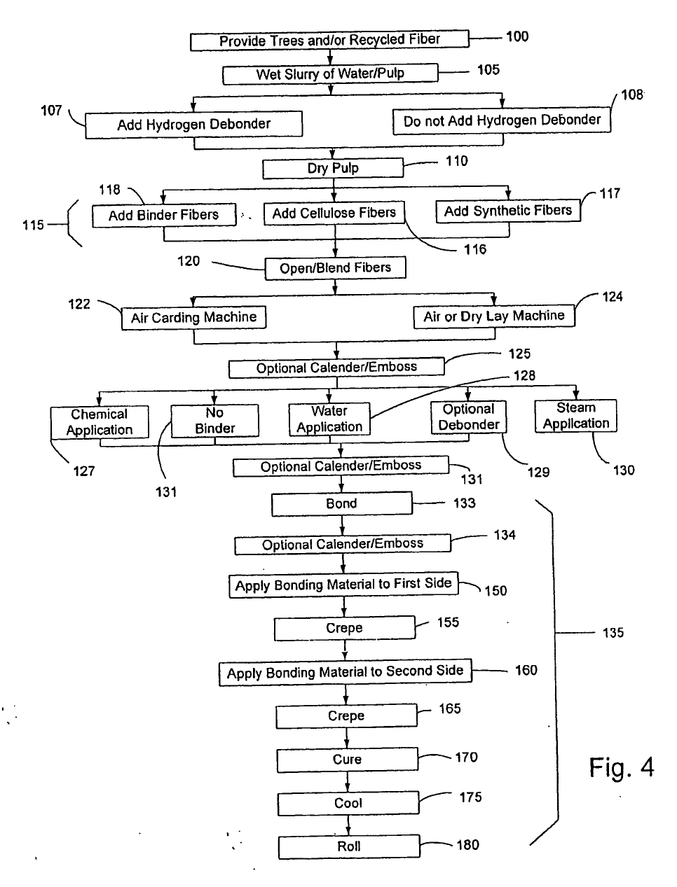

FIG. 4 is a flow chart illustrating processes of forming a non-woven web of fibrous material to achieve desired characteristics, such as strength, bulk thickness, flexibility, and the like. The process in FIG. 4 starts by obtaining raw materials from trees, recycled materials, or other sources of fiber (step 100). In step 105, a slurry is formed and hydrogen bonds are created between the fibers. Additives can be added to the slurry if desired. Step 107 illustrates the addition of debonder and step 108 illustrates that in certain instances no debonder is added or necessary. If step 107 is followed, debonded pulp or fibers are produced. As should be apparent, debonder maybe applied to cellulose, fiber, or pulp in at least three ways: 1) as it is made in the pulp process, 2) using a spray station and dryer as it is processed in the fiber preparation portion of the air-laid line prior to being introduced to the forming head, and 3) sprayed on the web after being formed by/in the forming head, but prior to the web being processed in the oven.

Water in the slurry is allowed to evaporate (i.e., the slurry is dried) and dry pulp is created (step 110). Other fibers can be added to the pulp created in step 110, as is shown in step 115. These fibers can include fibers such as cellulose (step 116), synthetic fibers (step 117), binder fibers (step 118) or combinations thereof. As noted above, in one embodiment, binder fiber plays an important role.

The combination of fibers is blended or processed in a manner that is referred to as opening the fiber, as shown in step 120. The blended or opened fibers are provided to a dry-forming machine, which can include a dry-carding machine (step 122) or dry- laid or forming machine (step 124). The dry-forming machine forms the fibers into a web. The web can be calendered (to adjust thickness, for example) or embossed (to, for example, impart a pattern on the web), if desired, as shown in step 125. A binder or binding agent such as a chemical (step 127), water (step 128), debonder (step 129), or steam (step 130) can be added to the web formed in the dry-forming machine (at prior steps 120 or 122), but such a binder is not required and need not be used, as shown in step 131. The sheet is then bonded or cured in an oven or other device (step 133). For example, in one instance if a chemical binder is added, the bonding in step 133 corresponds to the type of chemical binder added. However, if binder fiber is added in step 118, but no binder is added in step 131, then an oven is used to melt the binder fiber in step 133. Optionally, step 133 can be modified by introducing steam into the curing process. For example, steam can be introduced into an oven. Embossing and calendering can also be performed (step 134) after the curing step 133.

As should be apparent to one of ordinary skill in the art upon review of FIG. 4 numerous other combinations are possible. In one of the possible combinations, a dry-laid web or sheet is bonded only with hydrogen bonds. It is also possible to create a web by utilizing binder fibers, chemical binding agents, and water or steam, individually or in combination. However, in many embodiments, regardless of the bonding agent or technique used, it is desirable, as noted above, to form the base non-woven web so that it is strong enough to be printed and pressed to a dryer, but weak enough to develop bulk during creping.

Once the sheet is bonded in step 133 it is delivered to a creping process (step 135). The creping process 135 includes the steps discussed above with respect to FIG. 2 and the creping line 26. A first side of the sheet is printed with a chemical bonding material, such as latex, in a predetermined pattern (at step 150). The amount of bonding material and the pattern printed on the first side of the layer are generally controlled to provide the layer with specific characteristics. The sheet is then creped (step 155). If desired, the second side of the sheet is treated with a bonding material (step 160) and a second or double creping can be performed (step 165). The bonding material is then cured (step 170). The sheet is cooled (step 175) and then rolled on a drum to create a parent roll (step 180).

In some embodiments, the disadvantages of wet-laid forming are reduced because dry-forming processes are used instead of wet-laid processes. In addition, increased costs in raw materials due to the use of binder fiber and the like are believed to be offset by the elimination of the wet-laid processes. Strength is increased due to the use of longer fibers. Absorbency is enhanced in contrast to traditional air-laid materials because, in contrast to using a film of adhesive that covers the entire base web, adhesive is printed upon the web so that it covers, in some embodiments, only about 30 to about 50 percent of the surface of the web. Bulk is increased by the creping process carried out in some embodiments, and desirable hand feel or softness is achieved due to limiting the surface area upon which adhesive is printed or applied. Certain embodiments have advantages over wet-laid processes due to lower equipment costs, operation costs, labor costs, utility costs, and water requirements as compared to wet-laid techniques. In addition, wet strength and bulk are generally enhanced as compared to webs produced using wet-laid processes. Generally, the creping processes described herein exhibit decreased cost, increased bulk, and increased strength as compared to wet-laid creping processes due, at least in part, to the use of longer fibers and less binder. Finally, in some embodiments the air-laying processes have advantages over wet-laid processes because longer fiber may be used.

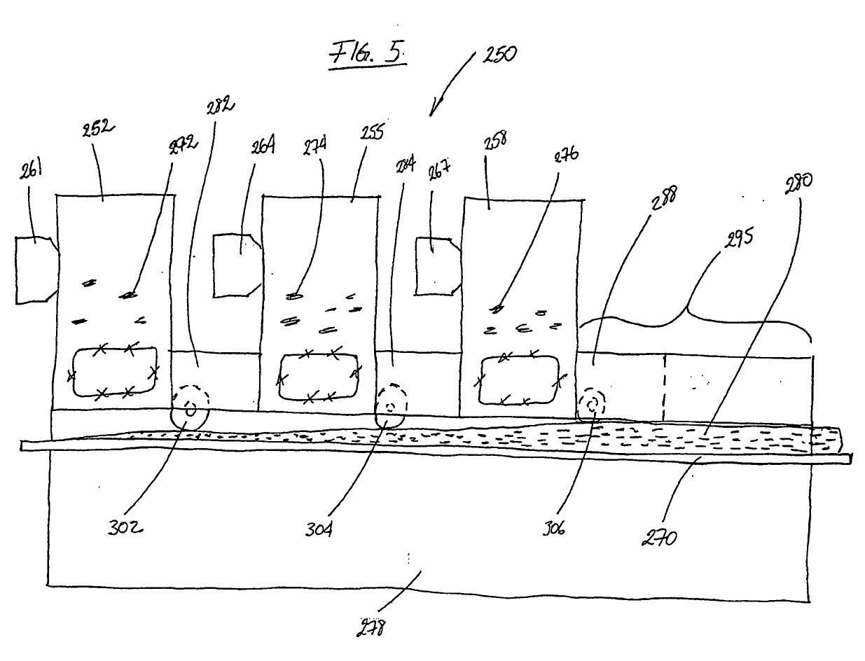

FIG. 5 illustrates an exemplary air-laying machine 250 that includes three forming boxes 252, 255, and 258. Each box has an associated fiber inlet 261, 264, and 267. The machine 250 operates in a manner that is similar to the operation of the forming box or former 10. The three forming boxes 252, 255, and 258 are positioned above a conveyor table 270. The conveyor table 270 is made from a mesh material or otherwise includes a plurality of openings for concurrently allowing air to flow therethrough and retain fibrous material thereon. Fibrous material 272, 274, and 276 travels from the inlet through each forming box. The fibrous material can include the same fibers noted above and similar variations and combinations. A vacuum source 278 is located underneath the conveyor table 270 and generates an air current that pulls the fibrous material onto the conveyor table 270 to form a web or sheet 280 of fibrous material. In the embodiment shown, the fibrous sheet 280 is formed in three layers: a first layer is formed by the box 252, and a second and third layers are formed by the boxes 255 and 258.

Vapor or steam boxes 282, 284, and 288 are placed directly adjacent to each forming box 252, 255, and 258, respectively. In the embodiment shown, the steam box 288 is located within the entrance of an oven 295. The sheet 280 is subjected to a vapor, mist, fog, spray, or steam (which for ease of description are collectively and generically referred to as a “suspension”) as it passes under each steam box 282, 284, and 288. In one embodiment, the suspension is generated with water. Applying a water suspension to the fibrous materials provides hydrogen atoms to help create hydrogen bonding between at least some of the fibers.

The embodiment shown in FIG. 5 also includes three optional calender rolls 302, 304, and 306. As shown, each calender roll is located within one of the steam boxes 282, 284, and 288. These optional calender rolls can be used to control the thickness of the sheet 280. The calender rolls can also be patterned to impart a desired pattern on the sheet 280 or each layer thereof. The calender rolls can also be heated to help maintain the sheet 280 at a desired temperature.

Another manner in which a pattern may be imparted to the sheet 280 is by constructing the conveyor table 270 with a patterned conveyor belt. (Imparting a pattern on the sheet can be used to increase the bulk or bulk density of an end product, whether accomplished using a pattern-forming belt or embossing rolls). In certain embodiments, the sheet 280 is partially or lightly wetted by the application of a suspension in the steam boxes 282, 284, and 288 or a spray station. In such a state, sufficient vacuum can be applied so that the surface of the sheet conforms to the pattern of the conveyor table. By wetting the sheet, vacuuming it into the conveyor table, and drying it, the sheet retains the pattern of the conveyor belt (or forming fabric). By varying the pattern of the belt, a desirable bulk to basis weight ratio can be achieved. This is helpful when laminating two or more sheets together to create a multi-sheet product with high bulk and absorbency characteristics. In some embodiments, sheets are laid on top of each other or laminated such that an end product with voids between the layers of sheets is formed. These voids can increase the insulating characteristics of the end product. The voids can also hold fluid and, thus, enhance the absorbency of the end product. By varying the patterns formed in the sheets, the number of layers, the offset of the layers, or a combination of some or all of these actions, the bulk density and absorbency of the end product can be varied.

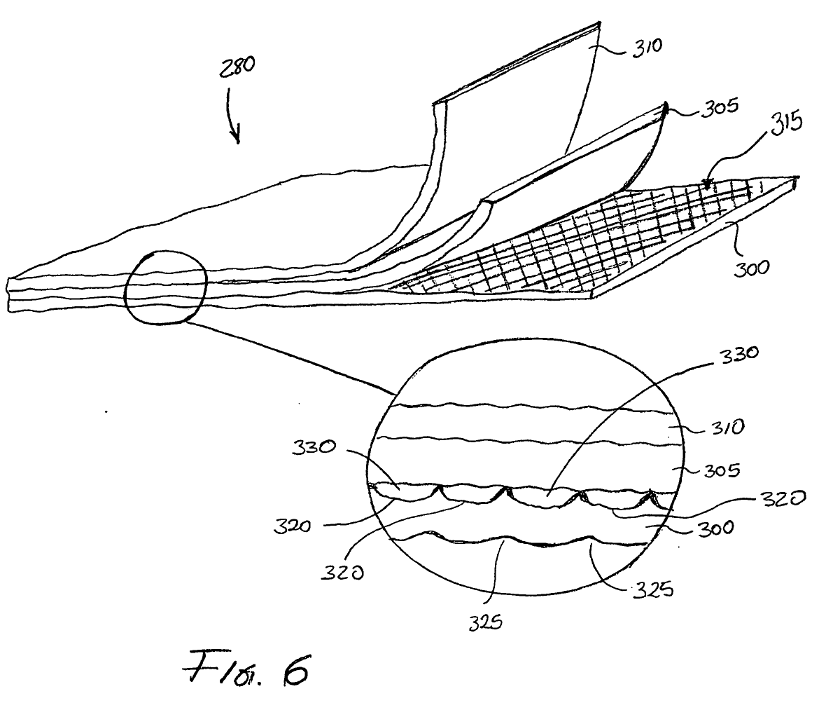

For example, FIG. 6 illustrates schematically a section of multi-layered sheet 280 including a first layer 300, a second layer 305, and a third layer 310. As indicated above, the first layer 300 may be formed by laying fibrous material 272 onto conveyor table 270 including a patterned conveyor belt to form a pattern 315 on one face of the first layer 300. Optional calender roll 302 can also include a patterned surface that contributes to forming the pattern 315 on the first layer 300. As a result of laying fibrous material onto the conveyor table 270 with the patterned conveyor belt, the first layer 300 includes valleys 320 and may also include depression or hollow areas 325. It is to be understood that the conveyor table 270 and optional calender roll 302 may include any desirable pattern to control bulk density of an end product. As shown in FIG. 5, fibrous material 274 is laid or vacuumed onto the first layer 300, forming the second layer 305, and fibrous material 276 is laid or vacuumed onto the second layer 305, forming the first layer 310. Alternatively, calender rolls 304 and 306 may also include patterned surfaces to create patterns onto a face of each of the second layer 305 and the third layer 310, respectively, to further increase bulk density of the end product. Subsequent to laying the second layer 305, the first layer 300 and the second layer 305 form voids 330, which increase the bulk density of the end product.

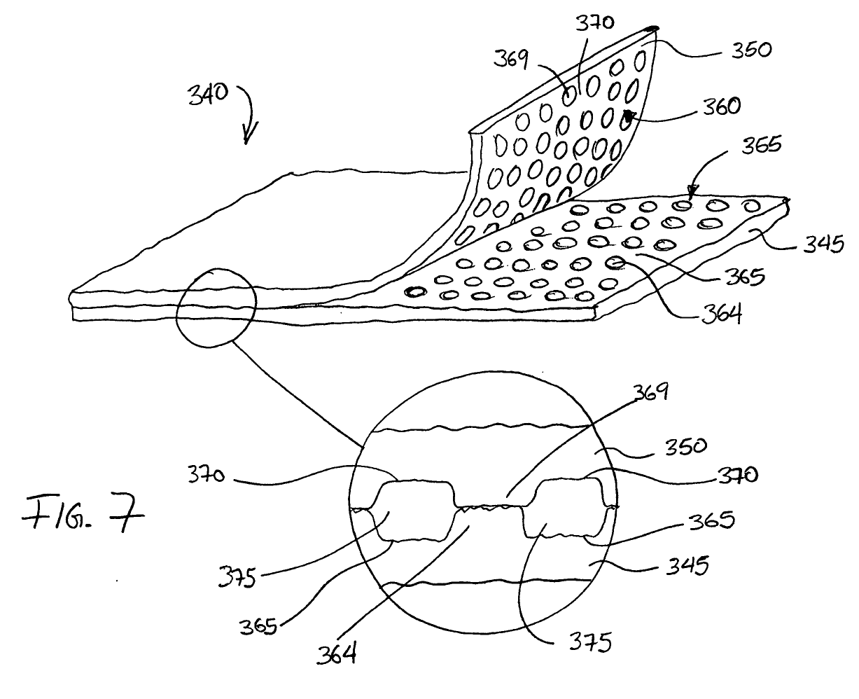

In another example, FIG. 7 illustrates schematically a multi-layered sheet 340 including a first layer 345 and a second layer 350. In this particular example, the first layer 345 may be formed separately from the second layer 350. In other words, it is possible that the system for forming non-woven web of FIG. 3 may include a feed roll including the second layer 350 so that the bottom of the second layer 350 (when originally formed) faces the bottom of the first layer 345 (when originally formed). The first layer 345 includes a pattern 355 and the second layer 350 includes a pattern 360. More particularly, pattern 355 formed on the bottom of the first layer 345 (when originally formed) defines plateaus 364 and valleys 365. Similarly, pattern 360 formed on the bottom of the second layer 350 (when originally formed) defines plateaus 369 and valleys 370. Notice that moisture vacuumed through the first sheet 345 and the second sheet 350 makes sheets 345 and 350 conform to the conveyor 270 to create patters 355 and 360.

As illustrated in FIG. 7, it is possible to increase the bulk density of an end product by forming the multi-layered sheet 340, where the patterned surfaces of the first layer 345 and the second layer 350 face each other forming voids 375 between valleys 365 and 370. It this particular example, it is possible to size the plateaus 364 and 369 to control the bulk density of the sheet 340. For example, plateaus 364 and 369 may be sized with sufficient area so that laying the second layer 350 onto the first layer 345 will substantially avoid contact of plateaus 364 and 369 with valleys 365 and 370 (as shown in FIG. 7). It is to be understood that the first layer 345 and the second layer 350 may include other suitable patterns to control the bulk density of the end product. It is also to be understood that sheet 340 can include additional layers, similar to sheet 280 shown in FIG. 6.

Once the sheet passes the third steam box 288 it enters the oven 295. The sheet is heated in the oven which helps evaporate the water applied in the steam boxes 282, 284, and 288. The dried sheet is held together in large part due to hydrogen bonding. If desired, the resulting sheet may be processed further through the bonding or creping processes.

As noted, in the embodiment shown, the steam boxes are directly downstream of the forming boxes to create a sealed or unitary environment. This prevents turbulence from disturbing the sheet as it is laid. In addition, a single conveyor is used to reduce transitions from one conveyor to another, which are often implemented in other systems, such as a transfer from a forming table to an oven. In addition the unitary forming and drying environment enables the system to be run at a relatively high speed because the sheet is not exposed to ambient air or turbulence, the sheet is given mass through the addition of water (as a suspension), and there are no transitions through multiple conveyors.

1. A method for making a non-woven web, the method comprising:
providing fibers to an air-lay machine;
laying the fibers on a forming table utilizing the air-lay machine to form a base non-woven web;
applying a suspension to the base non-woven web; and
heating the base-non-woven web to at least partially evaporate the suspension.

2. The method of claim 1, wherein providing fibers to an air-lay machine includes creating a mixture of fibers including cellulose and synthetic fiber.

3. The method of claim 2, wherein creating a mixture of fibers includes mixing pulp with binder fibers, each binder fiber including a core and an outer layer, wherein the core has a first melting temperature and the outer layer has a second melting temperature lower than the first melting temperature.

4. The method of claim 1, wherein laying the mixture includes utilizing an air carding machine.

5. The method of claim 1, wherein applying a suspension to the base non-woven web includes applying at least one of water vapor, water mist, water fog, water spray, and steam.

6. The method of claim 1, further comprising applying a bonding material to at least one side of the base non-woven web.

7. The method of claim 6, wherein applying the bonding material includes
providing a pair of rolls, at least one of the pair of rolls including a plurality of grooves;
supplying the bonding material to the grooves;
feeding at least one of the base non-woven web and the bonded web to the pair of rolls; and
applying bonding material to a first side of at least one of the base non-woven web and the bonded web.

8. The method of claim 6, wherein applying the bonding material includes
providing a spray station; and
spraying the bonding material onto at least one of the base non-woven web and the bonded web.

9. The method of claim 1, further comprising creping the non-woven web.

10. The method of claim 1, further comprising
mixing pulp-forming material and a liquid to create a slurry of pulp material;
drying the slurry to create pulp; and
creating fibers from the pulp.

11. The method of claim 1, further comprising calendering the bonded web.

12. The method of claim 1, further comprising controlling bulk density by forming a pattern in the bonded web.

13. A method for making a non-woven web, the method comprising:
providing fibers to an air-lay machine;
laying the fibers on a conveyor utilizing the air-lay machine to form a base non-woven web;
applying a suspension to the base non-woven web; and
forming a pattern in the base non-woven web to create a first patterned web;
laminating the first patterned web with a second patterned web to create a non-woven web with voids between the first and second patterned webs.

14. The method of claim 13, further comprising heating the first patterned web.

15. The method of claim 14, further comprising varying the patterning of the first patterned web, the second patterned web, or both to varying bulk density.

16. The method of claim 13, further comprising applying a bonding material to the first patterned web.

17. A method of forming a fibrous material including hydrogen bonds, the method comprising:
providing pulp and binder fibers to a dry-lay machine to form a layer of base fibrous material;
applying a suspension to the base fibrous material to create a hydrogen-bonded web;
heating the hydrogen-bonded web to at least partially evaporate the suspension and to at least partially melt the binder fibers to create a thermally-bonded web;
applying a first bonding material to a first side of the thermally-bonded web to create a bonding-material-treated web;
creping the bonding-material-treated web to create a creped web;
applying a second bonding material to a second side of the creped web to create a doubly-bonding-material-treated web;
creping the doubly-bonding-material-treated web to form a doubly-creped web;
curing the doubly-creped web; and
cooling the doubly-creped web.

18. The method of claim 17, further comprising
mixing pulp-forming material and a liquid to create a slurry of pulp material;
drying the slurry of pulp material to create a pulp; and
mixing pulp and binder fibers, each binder fiber having a core and an outer layer, wherein the core has a first melting temperature and the outer layer has a second melting temperature lower than the first melting temperature.

19. The method of claim 18, wherein heating the hydrogen-bonded web includes at least partially melting the outer layer of the binder fibers.

20. The method of claim 17, further comprising rolling the doubly-creped web to create a parent roll.

21. The method of claim 17, wherein applying a first bonding material to a first side of the thermally-bonded web includes spraying a chemical bonder onto the thermally-bonded web.

22. The method of claim 17, wherein providing pulp and binder fibers to a dry-lay machine includes providing an air-carding machine for mixing the pulp and binder fibers.

23. The method of claim 17, wherein curing the doubly-creped web includes
heating the doubly-creped web to a temperature sufficient to cure the first and second bonding materials.

24. A machine for forming a non-woven sheet of material, the machine comprising:
a dry forming head configured to accept a plurality of fibers and create a sheet of fibrous material;
a spraying station configured to apply a suspension to the sheet of fibrous material to create a bonded sheet;
an oven configured to receive the bonded sheet;
a first bonding station configured to apply a first bonding material to a first surface of the bonded sheet to create bonding-material treated sheet; and
a first creping dryer configured to crepe the bonding-material treated sheet.

25. The machine of claim 24, wherein the first bonding station includes a pair of rolls and a source of first bonding material, wherein at least one of the pair of rolls includes a plurality of grooves to transport the first bonding material and apply the first bonding material to the first surface of the thermally bonded sheet.

26. The machine of claim 24, further comprising a second bonding station configured to apply a second bonding material to a second side of the bonding-material treated sheet to create a doubly-bonding-material treated sheet.

27. The machine of claim 26, wherein the second bonding station includes a pair of rolls and a source of second bonding material, wherein at least one of the pair of rolls includes a plurality of grooves to transport the second bonding material and apply the second bonding material to the thermally bonded sheet.

28. The machine of claim 26, further comprising a second creping dryer configured to crepe the doubly-bonding-material treated sheet to create a doubly-creped sheet.

29. The machine of claim 26, wherein the first bonding material is substantially the same as the second bonding material.

30. The machine of claim 28, further comprising a curing station configured to receive the doubly-creped sheet at a first temperature and heat the doubly-creped sheet to a second temperature higher than the first temperature to create a cured sheet of fibrous material.

31. The machine of claim 30, wherein the second temperature is about 380° F.

32. The machine of claim 30, further comprising a cooling roll configured to receive the cured sheet at about the second temperature and cool the cured sheet to a third temperature lower than the second temperature to create a cooled sheet.

33. The machine of claim 24, further comprising a forming table with a patterned surface.

34. A machine for forming a non-woven web of material, the machine comprising:
a conveyor table;
a one or more forming heads positioned above the conveyor table, each forming head having at least one fiber inlet for receiving fibrous material;
a vacuum source located underneath the conveyor table and configured to generate an air stream that pulls fibrous material onto the conveyor table from the plurality of forming heads;
a one or more vapor boxes, each vapor box located adjacent to each forming box, each vapor box configured to deliver a suspension to a sheet of material; and
an oven located adjacent to one of the one or more vapor boxes.

35. The machine as claimed in claim 34, wherein at least two forming heads are positioned with respect to one another such that one forming head directs fibrous material onto the conveyor table to form a first layer of non-woven material and a second forming head directs fibrous material onto the first layer of non-woven material to form a second layer of non-woven material.

36. The machine as claimed in claim 35, further comprising at least one calender roll located within each vapor box.

37. The machine as claimed in claim 34, wherein the one or more forming heads, one or more vapor boxes, and oven are positioned directly next to each other in a manner to reduce disturbance of fibrous materials due to turbulence.

38. The machine of claim 34, wherein the conveyor table includes a patterned surface configured to have a web of material formed thereon.

39. A method of forming a sheet of non-woven material, the method comprising:
providing fibers to a forming head;
dry-laying fibers on a forming table to form a web;
wetting the web and vacuuming it into a patterned surface to create a pattern of plateaus and valleys in the web and form a first patterned web;
drying the first patterned web to fix the pattern of valleys; and
layering the first patterned web with a second patterned web to form a multi-layered sheet with plateau-to-plateau contact creating voids substantially between valleys to increase bulk and absorbancy.

40. A method of claim 39, further including sizing the plateaus sufficiently enough to avoid contact between plateaus from one of the first patterned web and the second pattern web with valleys from the other first patterned web and second patterned web.
